(19) United States
(12) Patent Application Publication
(10) Pub. No.: US 2009/0020577 A1
(43) Pub. Date: Jan. 22, 2009

(54) Hitch-mounted device

(76) Inventors: Jason Robert Johnson, Sano Point, ID (US); David Glen Riley, Hayden, ID (US)

Correspondence Address: JASON JOHNSON, PO BOX 1196, SANO POINT, ID, 83864, US

(21) Appl. No.: 11/880,216

(22) Filed: Jul. 21, 2007

(51) Int. Cl. B60R 9/06

(52) U.S. Cl. 224/519

(57) ABSTRACT

A hitch-mounted device is attachable to a trailer hitch of a vehicle for lifting, securing, and/or transporting various objects. Mounting brackets can be used to secure objects to a hitch-mounted device.

### BACKGROUND

Conventional hitch-mounted devices for securing objects to a vehicle trailer hitch are often cumbersome and difficult to operate. Such devices also may not adequately secure objects held by the device and/or may require additional steps to secure the objects to the device.

### SUMMARY

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

In view of the above, in one aspect this disclosure describes a hitch-mounted device attachable to a trailer hitch of a vehicle for lifting, securing, and/or transporting various objects.

In other aspects, this disclosure describes an attachment and locking mechanism for securing objects to a hitch-mounted device and to objects that can be secured to a hitch-mounted device.

### BRIEF DESCRIPTION OF THE DRAWINGS

In the figures, the left-most digit of a reference number identifies the particular figure in which the designated component or act first appears.

FIG. 1 is a perspective view showing an exemplary hitch-mounted device in one exemplary context lifting a wagon.

FIG. 2 is a perspective view of the exemplary hitch-mounted device of FIG. 1 in a lowered position, with an exemplary mounting bracket removed.

FIG. 3 is a perspective view of the exemplary hitch-mounted device of FIG. 1 in a raised position, with the exemplary mounting bracket securely held in place.

FIG. 4 is a progression of side views showing the exemplary hitch-mounted device of FIG. 1 in lowered-, mid-, and raised-and-locked positions.

FIG. 5 is an exploded view of the exemplary hitch-mounted device of FIG. 1.

FIG. 6 is a side view of the exemplary hitch-mounted device of FIG. 1, with a detail view showing the operation of a locking bar of the exemplary hitch-mounted powered device.

### DETAILED DESCRIPTION

### Overview

This disclosure is directed to hitch-mounted devices attachable to a trailer hitch of a vehicle for lifting, securing, and/or transporting various objects. The disclosure is also directed to mounting brackets and objects usable with hitch-mounted devices. Some exemplary objects that can be lifted, secured, and/or transported using the hitch-mounted devices and/or mounting brackets described herein include mobility vehicles (e.g., wheel chairs, scooters, etc.), recreational vehicles (e.g., four wheelers, bicycles, motorcycles, snowmobiles, boats, etc.), furniture (e.g., tables, chairs, dressers, chests, beds, etc.), testing equipment (e.g., soil sampling, sound testing, equipment, survey equipment, etc.), lawn and garden equipment (e.g., tractors, wheel burrow, push or riding lawnmowers, rototillers, snow blowers, wood splitters, trash cans, BBQ grills, coolers, etc.), sporting goods (e.g., golf carts, golf clubs, clay pigeon throwers, pet carriers, hunting carcass carrier, hunting blinds, tree stands, etc.), tools and equipment (e.g., car jacks, steps, ladders, tool boxes, welders, cutting torches, plasma cutter, saws, concrete cutters, concrete smoothing, generators, air compressors, etc.). However, it should be understood that virtually any other object could also be lifted, secured, and/or transported using the hitch-mounted devices with or without one of the mounting brackets shown or described herein.

### Exemplary Hitch-Mounted Device

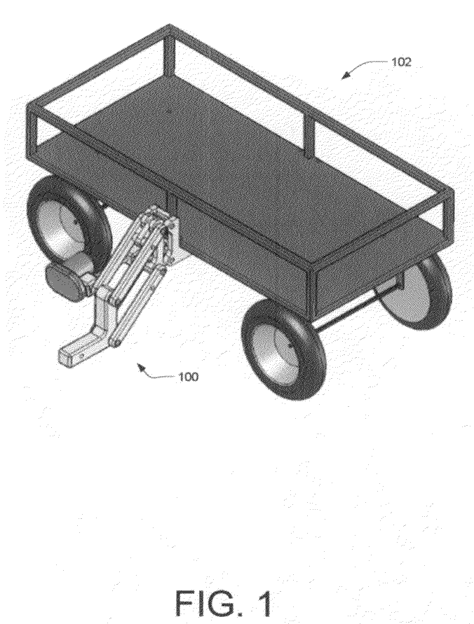

An exemplary hitch-mounted device is described with respect to FIGS. 1-6. FIG. 1 is a perspective view showing an exemplary hitch-mounted device 100 lifting an object 102 (depicted in this implementation as a wagon). The device 100 plugs into a trailer hitch receptacle of a vehicle and is operable to lift and secure the object 102 for transport.

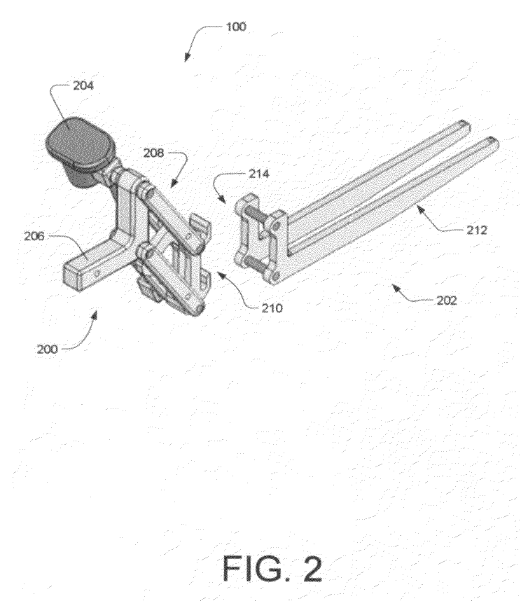

FIG. 2 is a perspective view of the exemplary hitch-mounted device 100 of FIG. 1 in a lowered position. The device 100 generally comprises a lifting portion 200 for lifting an object (not shown in this figure) coupled to a mounting bracket 202.

The lifting portion 200 includes an actuator 204, such as an electric screw drive actuator, linear actuator, hydraulic actuator, pneumatic actuator, or the like, coupled to the lifting portion 200 to drive the lifting portion 200 to lift the object. The actuator could additionally or alternatively comprise a manual version of any of the foregoing types of actuator.

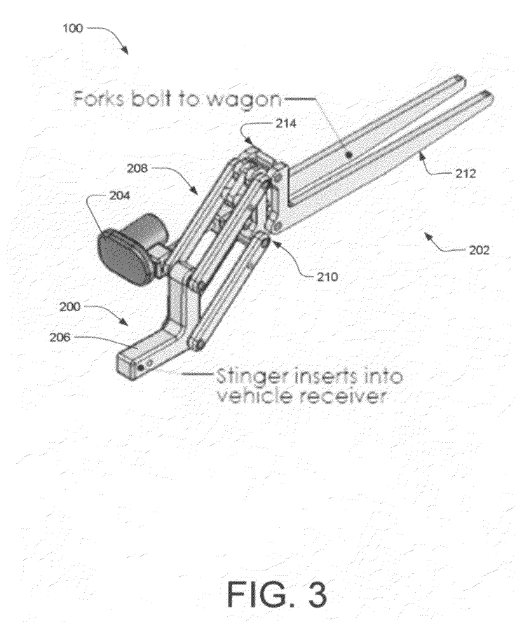

The lifting portion 200 also includes a stinger 206 for insertion into a receiver of a vehicle. Linkage 208 is pivotably coupled to the stinger 206 and to a mounting flange 210 configured to engage the mounting member 202. The mounting flange 210 is movable vertically relative to the stinger 206, between the lowered position shown in FIG. 2 for loading, and a raised-and-locked position shown in FIG. 3 for storage and/or transportation.

The mounting bracket 202 includes an object mount 212 configured to engage and secure an object, and a lift mount 214 configured to engage and couple to the mounting flange 210 of the lifting portion 200. In the implementation shown, the object mount 212 comprises a pair of parallel forks. However, in practice the object mount 212 of the mounting bracket 202 may take on virtually any size and shape configured to engage an object that is to be lifted, secured and/or transported. By way of example and not limitation, the object mount 212 could include one or more screws, bolts, clamps, notches, grooves, straps, magnets, locks, or other fastening features designed to secure an object to the mounting bracket 202. Also, while the lift mount 214 is depicted as a pair of parallel pins oriented to fit in correspondingly spaced troughs of the mounting flange 210, numerous other lift mount and mounting flange configurations are also possible. By way of example and not limitation, instead of pins, the lift mount could include one or more flanges, posts, tabs, screws, bolts, or other fastening features that engage one or more corresponding features of the mounting flange, or vice versa.

FIG. 3 is a perspective view of the exemplary hitch-mounted device of FIG. 1, showing the device in a raised position, with the exemplary mounting bracket securely held in place.

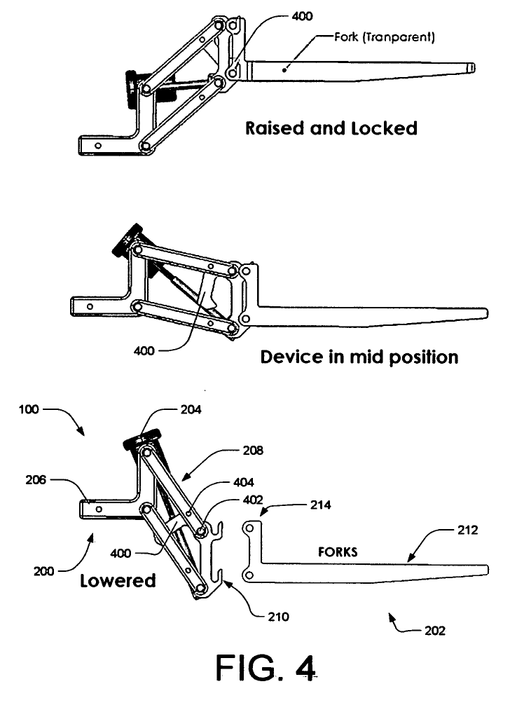

FIG. 4 is a progression of side views showing the exemplary hitch-mounted device of FIG. 1 in (from bottom to top) lowered-, mid-, and raised-and-locked positions. In the raised-and-locked position (the top view in FIG. 4), the forks of the mounting bracket 202 are shown as being transparent to more clearly illustrate how the mounting bracket 202 is locked in place to the lifting portion 200 by a locking bar 400.

As shown in the bottom view of FIG. 4, the locking bar 400 is fixedly coupled to the linkage 208 by a pair of pins 402 and 404. Thus, the locking bar 400 is made to pivot relative to the mounting bracket 210 in concert with linkage 208. When the lifting portion 200 is in a lowered position (the bottom view of FIG. 4), the locking bar 400 is in an unlocked position, in which the mounting bracket 202 can be freely attached to, and detached from, the mounting flange 210 of the lifting portion 200. As the lifting portion 200 is raised toward the mid-position in FIG. 4 (shown in the middle view of FIG. 4), the locking bar 400 begins to pivot toward the mounting flange 210. When the lifting portion 200 is in a raised position (shown in the top view of FIG. 4), the locking bar 400 is moved into a locked position, in which the locking bar 400 abuts the top pin of the lift mount 214 and securely retains the bottom pin in the corresponding trough of the mounting flange 210. In this raised position, the mounting bracket 202 is securely locked to the lifting portion 200 and cannot be removed.

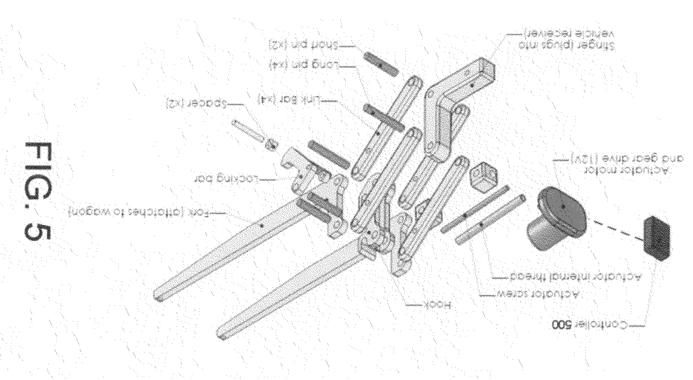

FIG. 5 is an exploded view of the exemplary hitch-mounted powered device of FIG. 1, showing the parts of the exemplary device. This illustration is not to show exact configuration of such components. Slight modification to such components may be necessary to allow for different lifting mechanisms and configurations of such mechanisms. The device 100 is controllable by a controller 500 which may comprise, for example, a manual switch or lever, an integrated circuit, a processor with suitable control logic, and/or any other known control device. Moreover, the controller 500 may be in wired or wireless communication with the device 100.

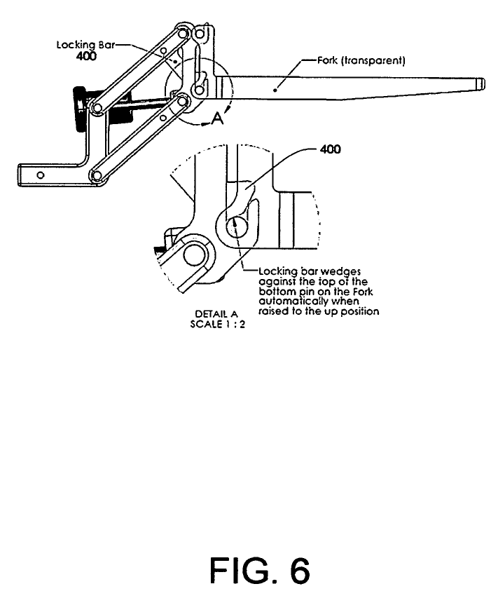

FIG. 6 is a side view of the exemplary hitch-mounted powered device of FIG. 1, with a detail view showing the operation of a locking bar 400 of the exemplary hitch-mounted powered device in more detail.

The various parts of the device 100 may be made of steel, aluminum, or other metals, plastics, carbon fiber, composites thereof, or any other suitable material. One or more components of the device 100 may be powder coated, galvanized, painted, or otherwise subjected to one or more chemical or physical processes to enhance the physical properties of the component.

The device 100 could additionally or alternatively be configured to pivot an object side-to-side instead of, or in addition to, up-and-down. In the simplest example, the device 100 could simply be rotated 90 degrees about an axis parallel to the stinger 106 and then inserted into the trailer hitch of a vehicle. In that manner, the device 100 could be used to move an object side-to-side. Of course, numerous other arrangements that provide vertical and/or lateral movement of an object using the hitch-mounted device are also possible.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary.

What is claimed is:

1. A hitch-mounted apparatus comprising:
a stinger for connection of the apparatus to a hitch of a vehicle; and
a lifting mechanism coupled to the stinger.

2. An apparatus as shown and described herein.
